(19) United States
(12) Patent Application Publication
(10) Pub. No.: US 2023/0099542 A1
(43) Pub. Date: Mar. 30, 2023

(54) Traffic Control Safety Gloves

(71) Applicant: Douglas Bradshaw, Lakewood, CO (US)

(72) Inventor: Douglas Bradshaw, Lakewood, CO (US)

(21) Appl. No.: 17/936,653

(22) Filed: Sep. 29, 2022

Related U.S. Application Data
(60) Provisional application No. 63/249,740, filed on Sep. 29, 2021.

(51) Int. Cl. A41D 19/00; A41D 31/32

(52) U.S. Cl. CPC A41D 19/0024; A41D 31/32

(57) ABSTRACT

This present invention relates to a safety and traffic directing accessory, such as a glove or set of gloves. The glove has a palmar portion for substantially covering the palm of the hand of a wearer, a dorsal portion for substantially covering dorsal region of the hand, finger portions for accommodating fingers, a thumb portion for the thumb and a cuff portion for securing around the wrist. The palmar portion and inner surface of the finger portions and cuff portion (positioned in extension of palmar portion) are a bright, reflective red to indicate a stop signal. The dorsal portion and outer surface of the finger portions and cuff portion are a bright, reflective green to indicate a go signal. In use, the red color is shown to communicate a stop signal and green color is shown to communicate a go signal to drivers, pedestrians, and motorists.

### CROSS-REFERENCE TO RELATED APPLICATION

The present application claims priority to, and the benefit of, U.S. Provisional Application No. 63/249,740, which was filed on Sep. 29, 2021 and is incorporated herein by reference in its entirety.

### FIELD OF THE INVENTION

The present invention relates generally to the field of accessories for use in flow control of pedestrians, traffic, and other motive items. More specifically, the present invention relates to a novel set of safety gloves configured for controlling vehicular traffic and other motive flows. The palm region of each glove is a bright, reflective red and the back side of each glove is a bright, reflective green, the gloves may also contain other directional indicia. The red color can be shown to indicate a stop signal in order to halt the flow of traffic or motive flow and the green color is shown to indicate a go signal wherein the gloves are worn by an officer or other individual authorized to provide control to flow patterns, such as for making traffic directing hand gestures for maximizing visibility for drivers and pedestrians. Accordingly, the present disclosure makes specific reference thereto. Nonetheless, it is to be appreciated that aspects of the present invention are also equally applicable to other like applications, devices, and methods of manufacture.

### BACKGROUND

By way of background, law enforcement officers and other authorized individuals such as crossing guards, security personnel at public venues and other individuals, direct traffic to safely expedite the flow of traffic, pedestrians, and other motive devices such as bicycles with the purpose of preventing congestion, avoiding accidents, and providing maximum vehicular and other traffic movement or flow. Generally, movement or flow of most heavily traveled areas is prioritized by allowing longer periods of running time, such as when exiting traffic from an event venue at the end of a performance, an accident or other emergency situations. Further, all the movement and turns of the vehicles, pedestrians, and other motive items are supervised and officers make sure that proper turns are made by people.

Hand gestures are commonly used by law officers and other authorized individuals to direct traffic and other flow patterns, and it is often the case that drivers, pedestrians, and other individuals may not understand hand signals, gestures, or just may not pay attention, thereby potentially running into or hitting the officer or other individual and may cause serious injury. Hand gestures, such as raising an arm vertically indicates all road users approaching the individual or officer to stop, extending both arms toward the left indicates movement of traffic or flow in front of the officer toward the left of the individual is allowed and similarly, extending both arms toward the right indicates movement toward the right of the officer or individual is allowed. Generally, palms are shown to stop the traffic and the back of the hand is shown to allow the traffic to flow in established directions.

Hand signals are extremely difficult to be viewed by drivers and others using motorways, walkways, and other thoroughfares especially at night and in the lowlight hours of the day and therefore, can become extremely dangerous for individuals assigned to traffic and control flow. Further, many officers and other authorized individuals use flashlights which flash in red and green colors but such lights require repeated recharging and are heavy, bulky, and expensive. The hands of the officers are occupied in holding the flashlight and therefore, can be discomforting for individuals and officers when holding the flashlight or other similar appliances for long periods of time.

Due to inherent issues with conventional hand signals and other means such as flashlights and whistles for directing traffic used by authorized individuals and officers, traffic control personnel desire a way that improves their safety and provides effective traffic control and flow.

Therefore, there exists a long-felt need in the art for a unique device that improves safety of traffic control officers and other authorized individuals while directing traffic. There is also a long-felt need in the art for an improved way of directing traffic that maximizes visibility and safety and helps to reduce accidents. Additionally, there is a long-felt need in the art for an improved means of directing traffic and other traffic flow that ensures drivers and pedestrians can see whether they should be passing through an intersection. Moreover, there is a long-felt need in the art for a device that is easily used by traffic control officers and other authorized individuals. Further, there is a long-felt need in the art for a traffic directing aid that displays a red side and green side to show drivers whether to stop or go. Furthermore, there is a long-felt need in the art for a traffic and flow control aid that can be used at night and in other low light conditions. Finally, there is a long-felt need in the art for a device that can be easily used by traffic officers and helps to prevent accidents and serious injuries from occurring at traffic stops.

The subject matter disclosed and claimed herein, in one embodiment thereof, comprises a traffic directing accessory. The accessory such as a glove, is used for directing traffic for flow control in a non-communication manner. Identical gloves can be separately available for each hand of a user, one for the left hand and another for the right hand. Each glove has a palm portion for covering the palm region of the hand of a user, an opposite dorsal portion for covering the back of the hand of the user, a plurality of finger portions for accommodating fingers, a thumb portion for accommodating the thumb and a cuff portion for securing the glove around the wrist of the user. The palm portion and the continuous finger and cuff portion have a bright, reflective red color to indicate a stop signal; the dorsal portion, continuous finger portion and cuff portion have a bright, reflective green color to indicate a go signal. The traffic flow control accessory is configured to be worn by a traffic controlling officer or other authorized individuals for acting as a visual indicator even in low light areas while the user makes usual hand gestures for controlling and directing traffic. The reflective areas of the traffic and flow control accessory may include beaded or prismatic films or elements to increase the retro reflectivity of the areas. In addition, the gloves may be provided with additional directional indicia to aid in the movement of the flow. The traffic flow control accessory may also include RFID chips to aid in monitoring the location of the individual directing traffic and may further include Bluetooth connectivity to provide traffic information to an individual using the traffic control accessory when connected to a smart device so that the user may receive audio or video information.

In this manner, the safety gloves and accessories of the present invention accomplish all of the foregoing objectives and provides traffic control officers and other authorized individuals with a set of gloves designed to improve safety when directing traffic or controlling the flow of movement of people and vehicles. The palmar portion of the glove has bright reflective areas which includes a red color, and the dorsal portion has bright reflective areas with a green color allowing an officer or other authorized individual to show the reflective or red color area to indicate a stop signal and show green color to indicate a go signal. The reflective red and green color areas maximize visibility and safety, ensuring drivers and pedestrians can see whether they should be passing through an intersection at a designated time, thereby preventing accidents and serious injuries from occurring at traffic stops.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a traffic directing accessory such as gloves. The accessory or set of gloves includes a left-hand glove and a right-hand glove that are used for directing traffic in a non-communication manner. Each glove is shaped and sized as per the size of a human hand and has a palmar or anterior portion for covering palmar region of the hand of a user, an opposite dorsal portion for covering the back of the hand of the user, a plurality of finger portions for accommodating fingers, a thumb portion for accommodating the thumb and a cuff portion for securing the glove around the wrist of the user. The palmar portion, the finger portion's inner surface and cuff portion's inner surface have bright, reflective areas and colored areas, such as a red color to indicate a stop signal; the dorsal portion, the finger portion's outer surface and cuff portion's outer surface have bright, reflective areas and colored areas, such as a green color to indicate a go signal. The gloves are configured to be worn by a traffic controlling officer for or other authorized individual acting as a visual indicator while the user makes usual hand gestures for controlling and directing traffic and other flow movements.

In yet another embodiment, a traffic guidance accessory is disclosed. The traffic guidance accessory is configured to fit over the hand of a user and features a palm side, a dorsal side, finger portions configured to accommodate fingers, a thumb portion for the thumb, a cuff portion for securing around the wrist; the palm side, the inner surface of the finger portions, thumb portion and the cuff portion have a reflective surface; the dorsal side, the outer surface of the finger portions, thumb portion and the cuff portion have a reflective surface; the reflective surface is shown to drivers to emulate a stop signal using colors, indicia, or graphics when traffic directing hand gestures are made by a wearer, and the reflective surface is shown to the drivers to emulate a go signal using colors, indicia, or graphics. The accessory is made of elastic, durable, and waterproof materials and provides visibility in night or lowlight condition ensuring drivers, pedestrians and other users of the motorways, thoroughfares and other traffic flow areas can see the directed signal to prevent accidents and serious injuries from occurring at traffic stops.

An additional embodiment of the presently described invention, includes a set of safety gloves used to control vehicular traffic. The gloves are designed to act as a visual indicator to communicate a stop or go signal without the need to use audible tones, sounds or signals such as a voice or whistle. Each glove of the set of safety gloves has a front portion formed of a palm region, inner surface of fingers portion, inner surface of thumb portion and inner surface of cuff portion; the front portion is bright and reflective and may have a colored area such as red in appearance to indicate a stop signal; a back portion formed of dorsal region, outer surface of fingers portion, outer surface of thumb portion and cuff portion; the back portion is bright and reflective and may have a colored area such as green in appearance to indicate a go signal; wherein the wearer performs traffic controlling hand gestures showing a front portion to stop drivers, pedestrians and motorist; and the wearer performs traffic controlling hand gestures showing the back portion to allow drivers, pedestrians and motorist to go.

In yet another embodiment, a method of visually indicating stop and go signals by a traffic controlling officer or other authorized individual is described. The method includes the steps of providing a pair of gloves, each glove has reflective, colored area such as a red color on palm side and reflective green color on dorsal side; wearing the gloves on the right hand and left hand, respectively, such that the red color substantially covers the palm, inner surface of the fingers and wrist and the green color substantially covers the dorsal region, outer surface of the fingers and wrist of the office; making traffic controlling hand gestures by the officer, such that the red color is shown to drivers to indicate a stop signal and green color is shown to drivers to indicate a go signal. The colored or reflective areas may be surrounded by dark or light color areas so as to highlight the colored or reflective areas.

The reflective areas of the traffic and flow control accessory may include beaded or prismatic films or elements to increase the retro reflectivity of the areas. In addition, the gloves may be provided with additional directional indicia to aid in the movement of the flow of traffic. The traffic flow control accessory may also include RFID chips to aid in monitoring the location of the individual directing traffic and may further include Bluetooth connectivity to provide traffic information to an individual using the traffic control accessory when connected to a smart device so that the user may receive audio or video information.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of traffic directing accessory of the present invention in accordance with the disclosed architecture;

FIG. 2A illustrates a rear perspective view of one potential embodiment of traffic directing glove of the present invention in accordance with the disclosed architecture;

FIG. 2B illustrates a perspective view of one potential embodiment of the flow control accessory showing the reflective or directional area on the accessory in accordance with the disclosed architecture;

FIG. 3 illustrates a perspective view showing a method of using the safety gloves of the present invention in accordance with the disclosed architecture;

FIG. 4 illustrates a perspective view showing a method of using the safety gloves of the present invention to indicate a stop signal in accordance with the disclosed architecture;

FIG. 5 illustrates a perspective view showing a method of using the safety gloves of the present invention to indicate a go signal in accordance with the disclosed architecture;

FIG. 6 illustrates another potential embodiment of the safety glove of the present invention in the shape of a mitten in accordance with the disclosed architecture; and

FIG. 7 illustrates a perspective view of one potential embodiment of a kit for providing the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a unique accessory that improves the safety of traffic or flow control officers or other authorized individuals while directing traffic or other motive flows. There is also a long-felt need in the art for an improved way of directing traffic that maximizes visibility and safety. Additionally, there is a long-felt need in the art for an improved accessory for directing traffic that ensures drivers, pedestrians and other individuals can see whether they should be passing through an intersection. Moreover, there is a long-felt need in the art for an accessory that is easily used by traffic control officers and other authorized individuals. Further, there is a long-felt need in the art for a traffic directing aid device that displays different colors to aid in the flow control, such as a red side and green side to show drivers to stop or go. The colored areas may be enhanced by retroreflective elements such as prismatic or beaded elements. Furthermore, there is a long-felt need in the art for a traffic officer accessory that can be used at night or in other low light conditions. Finally, there is a long-felt need in the art for a flow control accessory that can be easily used by traffic officers and prevents accidents and serious injuries from occurring at traffic stops, intersections, and other areas where crossing patterns of traffic occurs.

The present invention, in one exemplary embodiment, is a set of novel safety accessories used for safely controlling vehicular, pedestrian, or other traffic. The accessories or gloves are designed to act as a visual or directional indicator to communicate a stop or go signal, or other traffic commands, that does not require the issuance of audible instructions when worn by a traffic control officer or other authorized individual. Each glove of the set of safety gloves has a front portion featuring a palm region, inner surface of fingers portion, inner surface of thumb portion and inner surface of cuff portion; the front portion is bright and reflective and may have a colored area, such as red in appearance to indicate a stop signal when shown to motorists and drivers; a back portion featuring a dorsal region, outer surface of fingers portion, outer surface of thumb portion and cuff portion; the back portion is bright and reflective and may have a colored area, such as green in appearance to indicate a go signal when shown to motorists, pedestrians, and drivers. The officer performs traffic controlling hand gestures showing the front portion to stop drivers and motorists; and the wearer performs traffic controlling hand gestures showing the back portion to allow drivers and motorists to go. The colored areas may be solid or may be provided in a pattern such as stripes, dots, squares, or any other suitable arrangement.

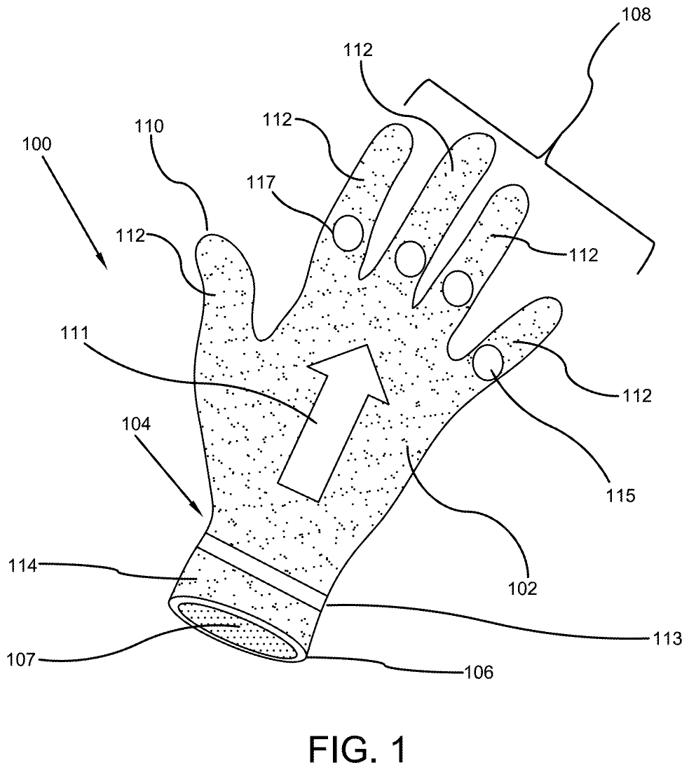

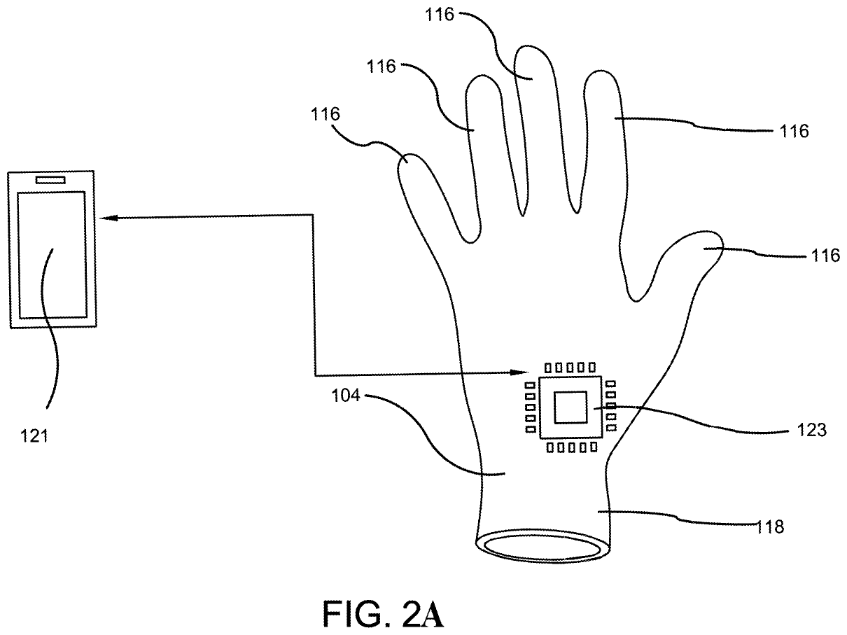

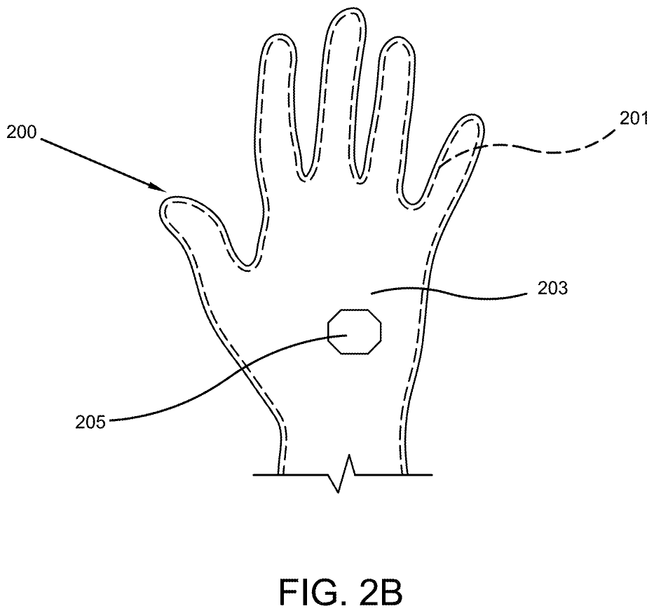

FIGS. 1-2 illustrate the front portion and back portion of the traffic and flow control accessory of the present invention, respectively. Referring initially to the drawings, FIG. 1 illustrates a perspective view of one potential embodiment of the traffic directing accessory or glove of the present invention in accordance with the disclosed specification. The traffic directing glove or accessory 100 of the present invention is designed to be worn by a traffic officer, law officer, other authorized individual to safely and easily direct the flow of traffic. The accessory or glove 100 has a shape, size, and configuration to be worn on a human hand and, in the preferred embodiment, a pair of gloves (one for the right hand and one for the left hand) are provided. The glove 100 is non-slippery and conforms generally to the shape of the human hand. Further, the glove 100 can be worn over a conventional glove such as a uniform glove or glove worn in cold climate by officers. More specifically, the glove 100 has a one-piece structure and has a palmar or anterior portion 102 and an opposite dorsal portion 104. The palmar portion 102 is configured to cover the palm underside and the dorsal portion 104 is configured to cover dorsal or back portion of the hand of the wearer. A cuff portion 106 of the glove 100 provides an opening 107 which allows a user's hand to be inserted into the glove 100 such that the finger portion 108 accommodates the fingers and the thumb portion 110 accommodates the thumb of a wearer. The finger portion 108 and the thumb portion 110 completely accommodate the fingers and thumb, respectively and therefore, the glove 100 covers and accommodates the hand of a wearer.

For easily providing traffic directions, the palmar portion 102, the finger portions and thumb inner surface 112 and cuff portion's inner surface 114 are provided in with a bright, reflective color such as red to emulate a stop signal, indicating drivers to stop their movement. It should be understood that different colors may be used as may be required in different jurisdictions or for different types of events. The dorsal portion 104, the finger portions and thumb's outer surface 116 and cuff portion's outer surface 118 are provided in a bright, reflective color such as green, to emulate a go-ahead signal indicating drivers, pedestrians, or other operators to resume movement (as illustrated in FIG. 2A). The bright colors increase visibility ensuring that the drivers, operators, and pedestrians clearly see the indicated traffic signal while using the glove 100 and provides safety to the wearer of the glove at night and low light condition. The glove 100 has a reflective coating making the glove 100 waterproof and further can have an additional layer of waterproof film. The accessory 100 may be provided with additional directional or graphical indicia 111 which may be made from a retroreflective tape and provided in a beaded or prismatic format, such as may be available from 3M or Avery Dennison. The directional or graphical indicia 111 may be, for example, an arrow to show the operators and pedestrians the direction they are to pursue or could be in the shape of stop sign to further illustrate the point that the operators and pedestrians are to stop. Additional retroreflective strips 113 may be provided near the cuff area 106 and the fingers may also be provided with retroreflective dots or strips 115, 117 to increase the visibility of the flow control accessory. The additional retroreflective strips and dots may be provided on one side or both sides of the flow control accessory 100.

FIG. 2A also provides a RFID chip 123 which is sewn on or embedded in the glove. The chip 123 is wirelessly connected to a smart device 121 such as a smartphone. The chip 123 is used to help show the location of the officer and the smart device 121 can be used to transmit information to the traffic control individual to alert them to traffic patterns, congestion, and whether they no longer need to provide directional assistance to motorists, operators, or pedestrians.

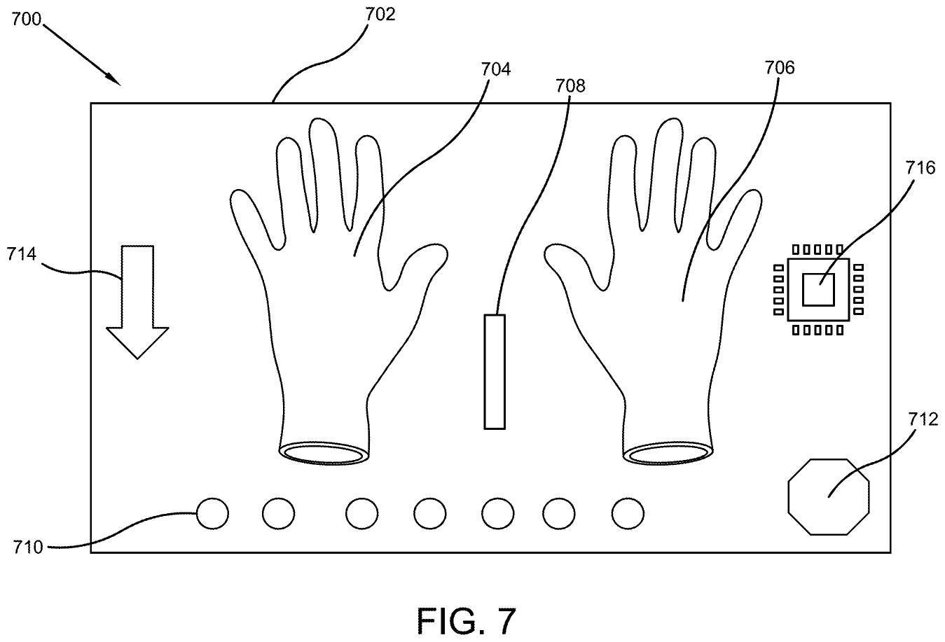

The glove or accessory 100 is elastic and may be made from weatherproof material so that it can be used in rain and inclement weather. The gloves of the invention function as a means of communication without having to issue audible commands for indicating a traffic signal and safely directing traffic or other flow. In one embodiment of the present invention, the gloves or accessories come in the form of a kit including a pair of gloves for both hands of a wearer as will be described in connection with FIG. 7. In cases, where the color on the glove starts fading, the glove can be flipped inside out and worn as the interior surface of the glove 100 has the same color pattern allowing to direct traffic signals.

FIG. 2B illustrates a front perspective of the traffic flow control accessory 200 illustrating the outer portion of the glove 201 and the inner portion of the glove 203 which has the colored and or retroreflective area as well as indicia 205, in this example, it is a stop sign to assist the traffic control person with communicating the requested flow control action. The inner colored area 203 is shown as being about 25% less area, but may be as much as 50 or 75% less than the area of the outer glove 203 so that the reflective and colored areas stand out against the background of the outer glove.

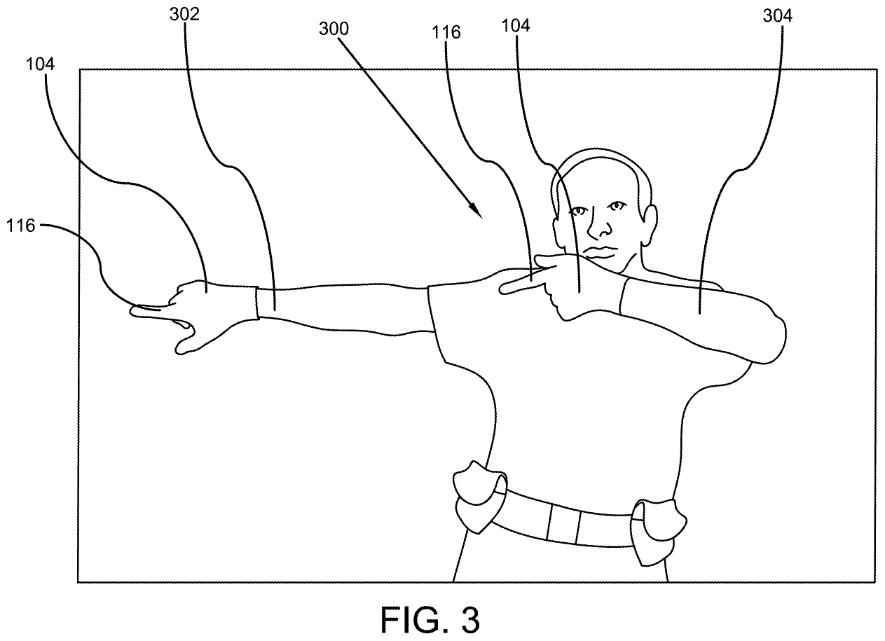

FIG. 3 illustrates a perspective view showing a method of using the safety gloves of the present invention in accordance with the disclosed architecture. In use, a traffic officer 300 wears a glove on each hand 302, 304 to make hand gestures to direct vehicular traffic. As illustrated, the officer 300, for example, makes hand gestures to direct drivers to make a left turn with the dorsal region 104 shown to the motorists, operators, or pedestrians. Accordingly, the bright, reflective green color of the dorsal region 104 and outer surface 116 of the finger portion 108 are visible to the motorists, thereby acting as a visual indicator for a “go” signal. As the green color is reflective, it is visible from long distances and even in low light, thereby ensuring that drivers easily see the directions made by the officer or traffic control individual 300.

The gloves or safety accessory can be used by anyone, such as a driver, to indicate to other drivers to indicate a stop or go signal. For example, a driver can extend his/her hand from a vehicle while driving, with the palm region showing to a driver behind him/her to indicate a stop signal (the rear driver is shown bright red color). The gloves can also be worn by supervisors, security guards, and other individuals in scenarios where people wear masks, and it can be difficult to be heard. It should be appreciated that the traffic directing gloves of the present invention are extremely helpful to assist traffic officers to safely and conveniently direct traffic. The glove 100 has a one-piece structure, is easy to wear and is re-usable.

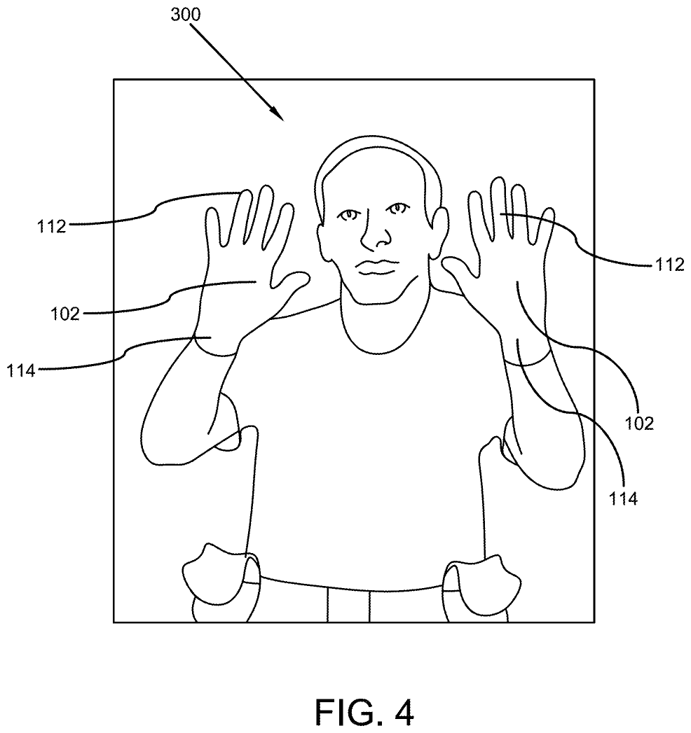

FIG. 4 illustrates a perspective view showing a method of using the safety gloves of the present invention for indicating a stop signal in accordance with the disclosed architecture. In use, the traffic officer 300 wears a glove on each hand 302, 304 to make hand gestures to direct vehicular traffic. As illustrated, the officer 300, for example, shows the front region including the palm region 102 and inner portions 112, 114 to direct drivers to stop movement. Accordingly, the bright, reflective material is visible to the motorists, thereby acting as a visual indicator for a stop signal. As the red color is retroreflective, it is visible from long distances and even in low light, in that it reflects oncoming light back to the source of the light making the signal indication visible, thereby ensuring that drivers easily see the directions made by the officer 300.

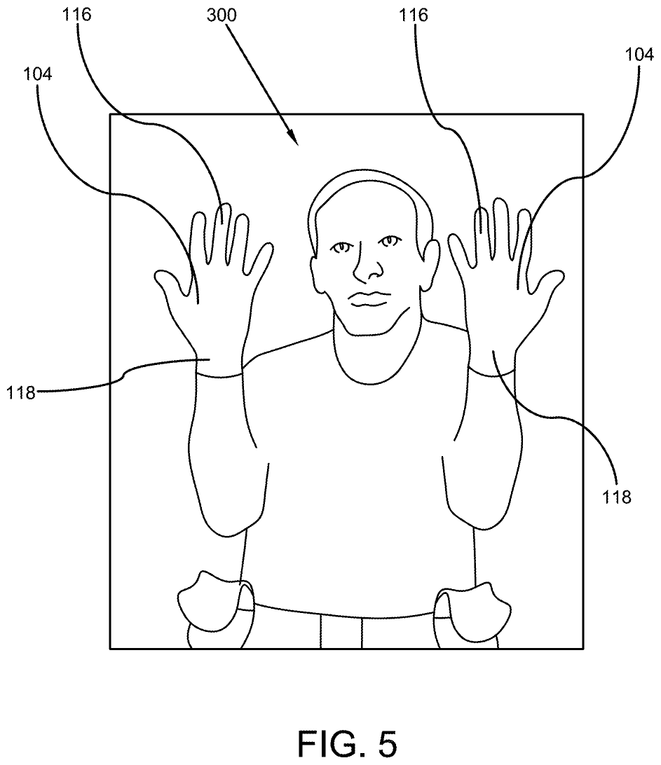

FIG. 5 illustrates a perspective view showing a method of using the safety gloves of the present invention to indicate a go signal in accordance with the disclosed architecture. In use, the traffic officer 300 wears a glove on each hand 302, 304 to make hand gestures to direct vehicular and other traffic. As illustrated, the officer 300, for example, shows the back portion of the gloves including the dorsal region 104 and outer portions 116, 118 to direct drivers to resume movement. Accordingly, the bright, retroreflective areas are visible to the motorists, pedestrians, and operators, thereby acting as a visual indicator for a “go” signal.

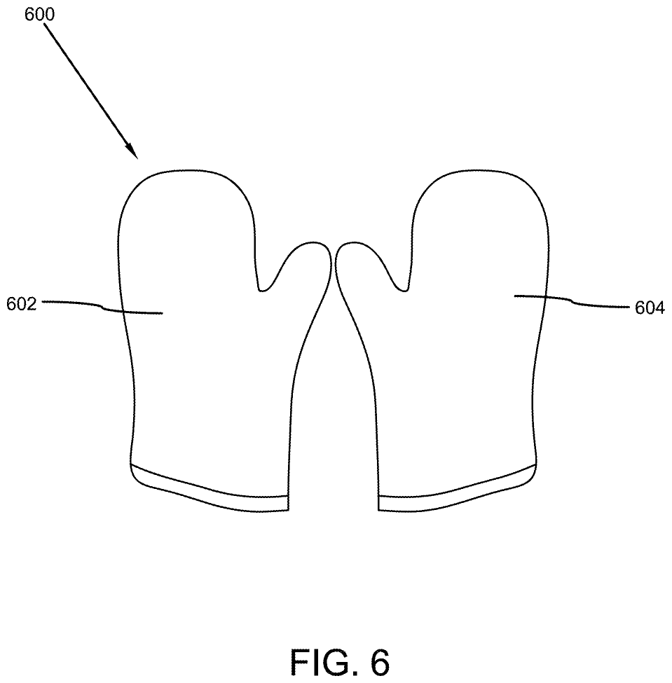

FIG. 6 illustrates another embodiment of the safety glove of the present invention in the shape of a mitten in accordance with the disclosed architecture. For officers that like to wear mittens in winter, the glove 600 of the present embodiment is in the form of a mitten with the front portion 602 configured to cover palm with a bright, reflective area and the back portion 604 configured to cover dorsal region of hand with a bright, reflective area. The mitten glove 600 can be worn over any conventional mittens worn by officers.

FIG. 7 provides a kit 700 which includes a container 702 which is suitable for retail as well as online sales. The kit 700 includes at least a pair of gloves 704 and 706 and it should be understood that more than one pair of gloves are provided. The kit 700 further includes one or more retroreflective strips 708 which may be sewn on or adhered by adhesive, such as a permanent adhesive which has a removable release liner. A number of different colored retroreflective dots 710 are also provided and can be applied to different portions of the gloves such as to the finger and thumb areas to increase the reflectivity of the gloves. The kit may further include a chip 716 which can be programmed and wirelessly connected to a smart device such as a smartphone to provide traffic and other relevant information from a central dispatch. The retroreflective dots and strips 710 and 708, respectively, are made from one of a beaded or prismatic material. The beads in the beaded material range from 0.59 mm to 1.68 mm with about 0.84 mm to about 1.68 mm being preferred. The prismatic material uses micro prismatic, truncated prisms. The kit 700 may also include other directional or information materials such as an arrow 714 and a stop sign 712 which can also be adhered to the gloves through the use of a permanent pressure sensitive adhesive. The gloves may be made from natural, synthetic, or combinations of materials.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “traffic directing accessory”, “safety glove”, “glove”, “traffic accessory”, and “traffic guidance glove” are interchangeable and refer to the traffic directing safety glove 100, 600 of the present invention.

Notwithstanding the foregoing, the traffic directing safety glove 100, 600 of the present invention can be of any suitable size and configuration as is known in the art without affecting the overall concept of the invention, provided that it accomplishes the above-stated objectives. One of ordinary skill in the art will appreciate that the traffic directing safety glove 100, 600 as shown in the FIGS. are for illustrative purposes only, and that many other sizes and shapes of the traffic directing safety glove 100, 600 are well within the scope of the present disclosure. Although the dimensions of the traffic directing safety glove 100, 600 are important design parameters for user convenience, the traffic directing safety glove 100, 600 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A traffic control accessory comprising:
a glove having a palmar portion and a dorsal portion on an opposite side on the glove from the palmer portion;
the palmar portion and the dorsal portion are connected to finger and thumb portions and a wrist area opposite the finger portions;
the wrist area including an opening;
each of the palmar portion and the dorsal portion having an area for signaling traffic flow control instructions; and
the area may include a color and a retroreflective element.

2. The traffic control accessory as recited in claim 1, wherein the color of the palmar portion is red.

3. The traffic control accessory as recited in claim 2, wherein the color of the dorsal portion is green.

4. The traffic control accessory as recited in claim 1, wherein the retroreflective element is one of a beaded or prismatic material.

5. The traffic control accessory as recited in claim 4, wherein the beaded material includes beads that range in size from 0.59 mm to 1.68 mm.

6. The traffic control accessory as recited in claim 4, wherein the prismatic material is comprised of a plurality of micro prismatic, truncated prisms.

7. The traffic control accessory as recited in claim 1, wherein the retroreflective element is attached by one of a sewing or an adhesive.

8. The traffic control accessory as recited in claim 7, wherein the adhesive is a permanent adhesive covered by a release liner.

9. The traffic control accessory as recited in claim 1, wherein the retroreflective element provides directional graphics or an indica.

10. The traffic control accessory as recited in claim 1 further comprising a RFID chip embedded or attached to the glove, wherein the RFID chip is wirelessly connected to a smart device.

11. The traffic control accessory as recited in claim 10, wherein the smart device provides information on a traffic flow.

12. The traffic control accessory as recited in claim 1, wherein the area for signaling is less than an area of the glove.

13. A traffic safety directing accessory comprising:
a right-hand glove and a left-hand glove, each of the right and left hand gloves having a palmar and dorsal area, finger portions, a thumb portion and a wrist portion, with the wrist portion having an opening;
each of the right hand and left-hand gloves having a color on the palmar area and a color on the dorsal area and the color on the palmar area is different than the color on the dorsal area; and
each of the palmar and dorsal areas are reflective.

14. The traffic safety directing accessory as recited in claim 13 further comprising a plurality of retroreflective elements that are a select one beaded or prismatic.

15. The traffic safety directing accessory as recited in claim 14, wherein the plurality of retroreflective elements are attached by one of a sewing or an adhesive.

16. The traffic safety directing accessory as recited in claim 13, wherein the palmar area color is red and the dorsal area color is green.

17. The traffic safety directing accessory as recited in claim 13, wherein the palmar area and the dorsal area are smaller than a total area of each of the right hand and left-hand gloves.

18. The traffic safety directing accessory as recited in claim 13 further comprising a RFID chip attached or embedded in one of the right hand or left-hand gloves, wherein the RFID chip is wirelessly connected to a smart device.

19. A kit for providing a traffic safety directing accessory, the kit comprising:
a pair of gloves;
a set of strips of retroreflective materials;
a set of dots of retroreflective materials;
the set of strip and dots of retroreflective materials include one of prismatic or beaded materials; and
directional and informational retroreflective elements.

20. The kit for providing a traffic safety directing accessory as recited in claim 19 further comprising a RFID chip.
